(19) United States
(12) Patent Application Publication
(10) Pub. No.: US 2014/0067601 A1
(43) Pub. Date: Mar. 6, 2014

(54) SUPPLY CHAIN FINANCE PLANNING

(71) Applicants: Wen-Syan Li, Fremont, CA (US); Gufei Sun, Shanghai (CN); Heng Wang, Shanghai (CN)

(72) Inventors: Wen-Syan Li, Fremont, CA (US); Gufei Sun, Shanghai (CN); Heng Wang, Shanghai (CN)

(73) Assignee: SAP AG, Walldorf (DE)

(21) Appl. No.: 13/605,391

(22) Filed: Sep. 6, 2012

(51) Int. Cl. G06Q 40/00; G06Q 30/06

(52) U.S. Cl. 705/26.8; 705/38

(57) ABSTRACT

In accordance with aspects of the disclosure, a system and methods are provided for supply chain finance planning by generating a loan plan with a relatively low interest payment for an orders set having collateral related assets while maintaining a working capital reserve at a predetermined threshold. The systems and methods may include retrieving account information for buyers related to the collateral related assets, retrieving lending information for lenders and evaluating interest payment patterns for each lender based on the collateral related assets, generating one or more potential loan schemes for each lender based on accounts receivable patterns for each buyer and the interest payment patterns for each lender, and generating the loan plan with the relatively low interest payment for the orders set having the collateral related assets while maintaining the working capital reserve at the predetermined threshold based on the potential loan schemes for each lender.

### TECHNICAL FIELD

The present description relates to computer-based techniques for supply chain finance planning

### BACKGROUND

Generally, businesses need to maintain a certain level of cash reserve as working capital. For instance, if the working capital reserve level is too high, it may not be cost efficient. On the other hand, businesses may be at risk and may fail to operate consistently if the working capital reserve level is too low. As such, there exists a need to manage working capital in an efficient manner to maximize profits.

### SUMMARY

In accordance with aspects of the disclosure, a computer system may be provided for supply chain finance (SCF) planning including instructions recorded on a computer-readable medium and executable by at least one processor. The computer system may include a supply chain finance manager configured to cause the at least one processor to generate a loan plan with a relatively low interest payment for an orders set having one or more collateral related assets while maintaining a working capital reserve at a predetermined threshold. The supply chain finance manager may include a buyer handler configured to retrieve account information for one or more buyers related to the one or more collateral related assets of the orders set from a buyer database and evaluate accounts receivable patterns for each buyer related to the one or more collateral related assets of the orders set within one or more time intervals. The supply chain finance manager may include a lender handler configured to retrieve lending information for one or more lenders from a lender database and evaluate interest payment patterns for each lender based on the one or more collateral related assets of the orders set within the one or more time intervals. The supply chain finance manager may include a genetic algorithm handler configured to generate one or more potential loan schemes for each lender based on the accounts receivable patterns for each buyer and the interest payment patterns for each lender while maintaining the working capital reserve at the predetermined threshold. The supply chain finance manager may include a loan selection optimizer configured to generate the loan plan with the relatively low interest payment for the orders set having the one or more collateral related assets while maintaining the working capital reserve at the predetermined threshold within the one or more time intervals based on the one or more potential loan schemes for each lender.

In accordance with aspects of the disclosure, a computer-implemented method may be provided for supply chain finance planning. The computer-implemented method may include generating a loan plan with a relatively low interest payment for an orders set having one or more collateral related assets while maintaining a working capital reserve at a predetermined threshold by retrieving account information for one or more buyers related to the one or more collateral related assets of the orders set from a buyer database and evaluating accounts receivable patterns for each buyer related to the one or more collateral related assets of the orders set within one or more time intervals, retrieving lending information for one or more lenders from a lender database and evaluating interest payment patterns for each lender based on the one or more collateral related assets of the orders set within the one or more time intervals, generating one or more potential loan schemes for each lender based on the accounts receivable patterns for each buyer and the interest payment patterns for each lender while maintaining the working capital reserve at the predetermined threshold, and generating the loan plan with the relatively low interest payment for the orders set having the one or more collateral related assets while maintaining the working capital reserve at the predetermined threshold within the one or more time intervals based on the one or more potential loan schemes for each lender.

In accordance with aspects of the disclosure, a computer program product may be provided, wherein the computer program product is tangibly embodied on a computer-readable storage medium and includes instructions that, when executed by at least one processor, are configured to generate a loan plan with a relatively low interest payment for an orders set having one or more collateral related assets while maintaining a working capital reserve at a predetermined threshold. The instructions, when executed by the at least one processor, may be further configured to retrieve account information for one or more buyers related to the one or more collateral related assets of the orders set from a buyer database and evaluate accounts receivable patterns for each buyer related to the one or more collateral related assets of the orders set within one or more time intervals, retrieve lending information for one or more lenders from a lender database and evaluate interest payment patterns for each lender based on the one or more collateral related assets of the orders set within the one or more time intervals, generate one or more potential loan schemes for each lender based on the accounts receivable patterns for each buyer and the interest payment patterns for each lender while maintaining the working capital reserve at the predetermined threshold, and generate the loan plan with the relatively low interest payment for the orders set having the one or more collateral related assets while maintaining the working capital reserve at the predetermined threshold within the one or more time intervals based on the one or more potential loan schemes for each lender.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating an example system for supply chain finance planning by implementing a genetic algorithm for loan planning), in accordance with aspects of the disclosure.

FIG. 2 is a process flow illustrating an example method for supply chain finance planning by implementing a genetic algorithm for loan planning), in accordance with aspects of the disclosure.

FIG. 3 is a schematic diagram illustrating an example supply chain process, in accordance with aspects of the disclosure.

FIG. 4 is a schematic diagram illustrating an example parallelized genetic algorithm (GA) framework for supply chain finance (SCF), in accordance with aspects of the disclosure.

FIG. 5 is a schematic diagram illustrating an example chromosome representation, in accordance with aspects of the disclosure.

FIG. 6 is a block diagram illustrating an example framework for supply chain finance planning by implementing a genetic algorithm for loan planning), in accordance with aspects of the disclosure.

FIG. 7 is a process flow illustrating another example method for supply chain finance planning by implementing a genetic algorithm for loan planning), in accordance with aspects of the disclosure.

FIGS. 8-9 show various graphical illustrative examples of implementing the system and methods of FIGS. 1-7, in accordance with aspects of the disclosure.

### DETAILED DESCRIPTION

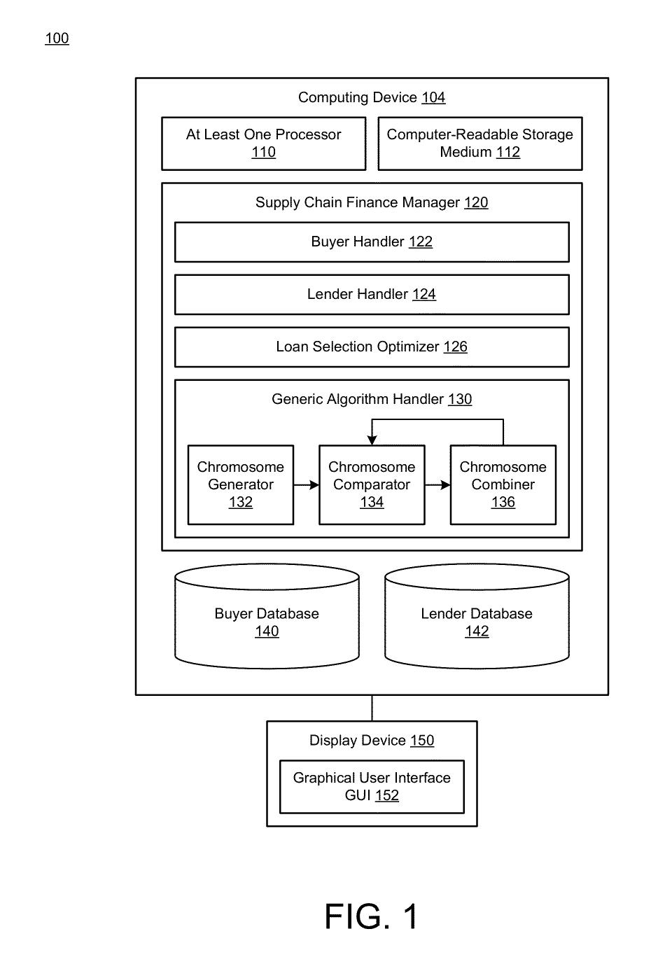

FIG. 1 is a block diagram illustrating an example system 100 for supply chain finance (SCF) planning by implementing a genetic algorithm for loan planning, in accordance with aspects of the disclosure.

In the example of FIG. 1, the system 100 comprises a computer system for implementing a supply chain finance (SCF) management system that may be associated with a computing device 104, thereby transforming the computing device 104 into a special purpose machine designed to determine and implement the loan planning process(es), as described herein. In this sense, it may be appreciated that the computing device 104 may include any standard element(s), including at least one processor(s) 110, memory (e.g., non-transitory computer-readable storage medium) 112, power, peripherals, and various other computing elements not specifically shown in FIG. 1. Further, the system 100 may be associated with a display device 150 (e.g., a monitor or other display) that may be used to provide a graphical user interface (GUI) 152. In an implementation, the GUI 152 may be used, for example, to receive preferences from a user for managing or utilizing the system 100. It should be appreciated that various other elements of the system 100 that may be useful to implement the system 100 may be added or included, as would be apparent to one of ordinary skill in the art.

In the example of FIG. 1, the supply chain finance management system 100 may include the computing device 104 and instructions recorded on the computer-readable medium 112 executable by the at least one processor 110. In an implementation, the supply chain finance management system 100 may include the display device 150 for providing output to a user, and the display device 150 may include the graphical user interface (GUI) 152 for receiving input from the user.

The supply chain finance management system 100 may include a supply chain finance manager 120 configured to cause the at least one processor 110 to generate at least one loan plan with a relatively low interest payment for an orders set having one or more collateral related assets while maintaining a working capital reserve (i.e., a cash reserve) at a predetermined threshold. In an implementation, the one or more collateral related assets of the orders set may include one or more of invoices, shipping certificates, acceptance certificates, and/or purchase orders as collateral related assets associated with one or more of the buyers, as described herein.

In an aspect of the disclosure, the predetermined threshold of the working capital reserve may refer to a cash reserve threshold that may be predetermined based on input received from a user. The cash reserve threshold may be adapted to consider a target cash reserve level (TCRL) for indicating when a working capital amount is equal to or at least greater than the target cash reserve level (TCRL). The cash reserve threshold may be adapted to consider a low cash reserve level (LCRL) for indicating when the working capital amount is within a range proximate to the target cash reserve level (TCRL). The cash reserve threshold may be adapted to consider a critical cash reserve level (CCRL) for indicating when the working capital amount is less than the target cash reserve level (TCRL), which may be considered a critically low level. The cash reserve threshold may be adapted to consider an excessive cash reserve level (ECRL) for indicating when the working capital amount is greater than the target cash reserve level (TCRL), which may be considered an excessively high level. These and various other related aspects are described in greater detail herein.

In the example of FIG. 1, the supply chain finance manager 120 may include a buyer handler 122 configured to retrieve account information for one or more buyers related to the one or more collateral related assets of the orders set from a buyer database 140 and evaluate accounts receivable patterns for each buyer related to the one or more collateral related assets of the orders set within one or more time intervals.

In the example of FIG. 1, the supply chain finance manager 120 may include a lender handler 124 configured to retrieve lending information for one or more lenders from a lender database 142 and evaluate interest payment patterns for each lender based on the one or more collateral related assets of the orders set within the one or more time intervals.

In the example of FIG. 1, the supply chain finance manager 120 may include a genetic algorithm handler 130 configured to generate one or more potential loan schemes for each lender based on the accounts receivable patterns for each buyer and the interest payment patterns for each lender while maintaining the working capital reserve (i.e., cash reserve) at the predetermined threshold. In an implementation, the genetic algorithm handler 130 may be configured to generate the one or more potential loan schemes for each lender based on using one or more collateral related assets of the orders set for a reduced interest rate for the relatively low interest payment while maintaining the working capital reserve (i.e., cash reserve) at the predetermined threshold. These and various other related aspects are described in greater detail herein.

In an implementation, the genetic algorithm handler 130 may include a chromosome comparator 134 that may be configured to compare a plurality of order-status chromosomes, wherein each order-status chromosome including the one or more potential loan schemes for each lender within the one or more time intervals based on the accounts receivable patterns for each buyer and the interest payment patterns for each lender. The chromosome comparator 134 may be further configured to compare each of the plurality of order-status chromosomes relative to the predetermined threshold of the working capital reserve, to thereby output a selected subset of the plurality of order-status chromosomes. The genetic algorithm handler 130 may include a chromosome combiner 136 that may be configured to combine order-status chromosomes of the selected subset of the plurality of order-status chromosomes to obtain a next generation of order-status chromosomes for output to the chromosome comparator 134 and for subsequent comparison therewith of the next generation of order-status chromosomes with respect to the predetermined threshold of the working capital reserve, as part of an evolutionary loop of the plurality of order-status chromosomes between the chromosome comparator 134 and the chromosome combiner 136. The chromosome combiner 136 may be further configured to combine the order-status chromosomes including selecting pairs of order-status chromosomes and crossing over portions of each pair of order-status chromosomes to obtain a child chromosome of the next generation. These and various other related aspects are described in greater detail herein.

In the example of FIG. 1, the supply chain finance manager 120 may include a loan selection optimizer 126 configured to generate the at least one loan plan with the relatively low interest payment for the orders set having the one or more collateral related assets while maintaining the working capital reserve (i.e., cash reserve) at the predetermined threshold within the one or more time intervals based on the one or more potential loan schemes for each lender. In an implementation, the loan selection optimizer 126 may be configured to evaluate each generated potential loan scheme for each lender and select a best potential loan scheme by considering a lowest interest rate for the relatively low interest payment from each lender while maintaining the working capital reserve at the predetermined threshold. These and various other related aspects are described in greater detail herein.

In an implementation, the loan selection optimizer 126 may be configured to select the selected order-status chromosome after a predetermined number of generations of the evolutionary loop, or after determining that the selected order-status chromosome satisfies the predetermined threshold of the working capital reserve. The loan selection optimizer 126 may be configured to monitor the evolutionary loop and select a selected order-status chromosome therefrom for implementation of the loan plan based thereon. In another implementation, at least a portion of the evolutionary loop may be executed using parallel processes in which each generation of order-status chromosomes may be divided into sub-groups for parallel processing thereof. These and various other related aspects are described in greater detail herein.

In an implementation, maintaining the working capital reserve (i.e., cash reserve) at the predetermined threshold may include maintaining a profit return rate at a predetermined threshold. In another implementation, maintaining the working capital reserve (i.e., cash reserve) at the predetermined threshold may include maintaining an asset-liability ratio at a predetermined threshold.

In accordance with aspects of the disclosure, the one or more collateral related assets of the orders set may refer to one or more of invoices, shipping certificates, acceptance certificates, and/or purchase orders as collateral related assets associated with one or more of the buyers.

In an implementation, the buyer handler 122 may be configured to evaluate the accounts receivable patterns for each buyer by receiving one or more purchase orders from each buyer related to the orders set, sending an invoice to each buyer after delivery of the one or more purchase orders, and receiving payment from each buyer or the rejected purchase order from each buyer after confirming whether the buyer accepted or rejected the delivery.

In an implementation, the buyer handler 122 may be configured to evaluate the accounts receivable patterns for each buyer based on purchase orders received from the one or more buyers, and wherein the lender handler is further configured to evaluate interest payment patterns for each lender based on the purchase orders received from the one or more buyers within the one or more time intervals.

In an implementation, the buyer handler 122 may be configured to evaluate the accounts receivable patterns for each buyer based on invoices sent to the one or more buyers after delivery of one or more purchase orders to the one or more buyers, wherein the lender handler 124 may be configured to evaluate interest payment patterns for each lender based on the invoices sent to the one or more buyers within the one or more time intervals.

In an implementation, the buyer handler 122 may be configured to evaluate the accounts receivable patterns for each buyer based on receipts paid by the one or more buyers for delivery of one or more purchase orders to the one or more buyers, wherein the lender handler 124 may be configured to evaluate interest payment patterns for each lender based on the receipts paid by the one or more buyers within the one or more time intervals.

In accordance with aspects of the disclosure, the term(s) working capital management, cash flow management, and similar terms are exchangeable. Further, the description(s) of means for controlling the cash level, cash reserve level, and/or working capital level within a desirable range or above a desirable level using a set of rules should be viewed as an example or implementation, and as such, one or more additional rules may be added to or implemented within the supply chain finance management system 100 and/or components thereof by adding them to one or more “fitness functions” in the loan planning algorithm presented herein.

Further, in accordance with aspects of the disclosure, there are types of financial activities that may impact daily working capital levels. Some examples include accounts receivable (AR) and accounts payable (AP). For instance, accounts receivable may refer to money owed to a business by buyers, clients, or customers, which may be shown on a balance sheet of the business as an asset. As such, accounts receivable may refer to accounting transactions relating to billing a buyer for ordered goods and/or services and receiving a subsequent payment from the buyer. In another instance, accounts payable may refer to money owed to a lender by a business, which may be shown on a balance sheet of the business as trade payables. For example, when an invoice is received from a lender, the invoice may be added to the balance sheet and removed when paid. Thus, accounts payable may be considered as a form of a loan or credit that lenders offer to a business by allowing payment for goods and/or services after receiving the goods and/or services. As such, accounts payable may refer to accounting transactions relating to paying a lender for ordered goods and/or services and providing a subsequent payment to the lender after receiving the ordered goods and/or services.

In an aspect of the disclosure, example requirement(s) for working capital management provides for maintaining a desirable or predetermined cash reserve level that may be set in a desired or predetermined manner. For instance, the working capital or cash reserve should be maintained above a TCRL. However, the working capital or cash reserve may drop below a LCRL for a particular number of days over a period or a number of consecutive days in a period. However, in any event, the working capital or cash reserve should not drop below a CCRL at any time. Since working capital or cash inflow may only be estimated and not controlled, then as accounts receivables are paid by customers, at least one parameter may be configured that refers to a confidence level of a payment inflow estimation strategy, wherein in some examples, the confidence level may be based on accounts receivable patterns for one or more related buyers and/or interest payment patterns for one or more related lender.

As such, the supply chain finance management system 100 of FIG. 1 (in particular, the supply chain finance manager 120) may be configured to provide an optimal or at least near-optimal loan planning solution, in a quick, efficient, and reliable manner. In an implementation, the system 100 may also be configured to provide one or more simulations of possible loan planning solutions (e.g., potential loan schemes that may be referred to as order-status chromosomes), as well as associated “what-if” scenario modeling of loan planning that allows for informed decisions about everyday business practices and transactions.

The system 100 may be configured to implement a randomized algorithm approach known as a genetic algorithm (GA), which may refer generally to a computer simulation of Darwinian natural selection that iterates through successive generations to converge toward a best solution in a problem/solution space. Such a genetic algorithm may be used by the system 100 to consider requirements and/or related parameters (e.g., working capital reserves including cash reserves) into the loan planning optimization process. Further, the supply chain finance management system 100 may be configured for recommending and/or selecting “best-available” loan plans.

In the system 100 of FIG. 1, the genetic algorithm approach may be implemented, for example, by creating a “chromosome” representing a possible solution to the problem of loan planning. Specific examples of such order-status chromosomes are described herein. However, generally speaking, it should be appreciated that such order-status chromosomes may include one or more potential loan schemes for each lender within one or more time intervals based on the accounts receivable patterns for each buyer and the interest payment patterns for each lender. Further, it should be appreciated that such potential loan schemes may be used to compare each of the order-status chromosomes relative to a predetermined threshold of the working capital reserve (i.e., cash reserve), to thereby output a selected subset of order-status chromosomes. Thus, there may be a single such order-status chromosome that may represent the single best loan planning solution for a given set of loan planning objectives to thereby optimize profits). However, optimization of potential loan schemes (i.e., order-status chromosomes) may be relative to needs of a user and various other factors, parameters, and/or requirements. Due to the nature of the genetic algorithms used herein, the supply chain finance manager 120 may find a “best” solution that is close to an optimal solution, even if the actual optimal solution is not identifiable as such.

In this regard, the supply chain finance manager 120 may be configured to optimize loan planning relative to one or more objectives. One such metric may include profitability. For example, some buyers and/or lenders may be more profitable than others, and/or profitability may be enhanced by exhibiting a preference for behaviors associated with increased profitability. On the other hand, other additional or alternative metrics may have value besides pure profitability. For instance, a gain in market share may be a valuable metric to consider.

As such, for example, the loan selection optimizer 126 may be configured for tuning preferences to provide designations between possible objectives of the supply chain finance manager 120, and it should be appreciated that various factors, parameters, and/or requirements may be considered to be necessary or optional. For instance, in scenarios in which profitability should be optimized, a full utilization of the genetic algorithm may be an option but not a requirement.

The supply chain finance manager 120 may be configured to utilize the genetic algorithm via the genetic algorithm handler 130 to create, compare, and combine multiple order-status chromosomes in a manner to create a new generation or population of order-status chromosomes for evaluation so that a subset thereof may be selected for reproduction and subsequent evaluation. In this way, each generation/population of order-status chromosomes may tend to converge toward an optimal solution for loan planning. The loan selection optimizer 126 may be configured to select a particular one of the loan planning solutions (i.e., potential loan schemes or order-status chromosomes) for use in loan planning.

In the example of FIG. 1, the genetic algorithm handler 130 may include a chromosome generator 132 that may be configured for generating one or more order-status chromosomes. Such order-status chromosome generation may occur at random or may include some initial guidelines or restrictions. The chromosome generator 132 may be configured to generate an initial population or set of order-status chromosomes, which may be evaluated by the chromosome comparator 134 configured for comparing each order-status chromosome including the one or more potential loan schemes for each lender within the one or more time intervals based on the accounts receivable patterns for each buyer and the interest payment patterns for each lender, and configured to compare each order-status chromosome relative to a predetermined threshold of the working capital reserve, to thereby output a selected subset of the order-status chromosomes, which may represent the best available loan plan. These and various other related aspects are described in greater detail herein.

The chromosome combiner 136 may receive the selected subset of the plurality of order-status chromosomes and may be configured to combine (e.g., crossover and mutate) order-status chromosomes of the selected subset of the plurality of order-status chromosomes to obtain a next generation (population) of order-status chromosomes for output to the chromosome comparator 134, which may then perform another, subsequent comparison therewith of the next generation of order-status chromosomes with consideration of the predetermined threshold of the working capital reserve, as part of an evolutionary loop of successive generations of the plurality of order-status chromosomes between the chromosome comparator 134 and the chromosome combiner 136. With each successive generation, the new population of order-status chromosomes may represent or include possible improved or near-optimal loan plan(s). New generations/populations may be iteratively created until either an optimal solution is met, or until factors, preferences, and/or requirements are met up to some pre-defined satisfactory level or threshold, or until a pre-determined number of generations is calculated, or until time runs out to compute new generations/populations (at which point a best solution of the current generation may be selected).

As referenced above, the loan selection optimizer 126 may be configured to monitor the evolutionary loop and to select a selected order-status chromosome therefrom for implementation of the loan plan based thereon. As referenced herein, the selected order-status chromosome/solution may represent either a best (optimal or near optimal) solution, or may represent a best-available solution. Thus, the loan selection optimizer 126 may be tasked with determining whether, when, and how to interrupt or otherwise end the evolutionary loop and extract the best, best-available, optimal, or near optimal solution. Then, in an instance, the loan selection optimizer 126 may output a selected order-status chromosome and/or execute an actual loan plan.

In the example of FIG. 1, it should be appreciated that the supply chain finance management system 100 is illustrated using various functional blocks or modules that represent more-or-less discrete functionality. However, such illustration is provided for clarity and convenience, and it should be appreciated that the various functionalities may overlap or be combined within a described block(s) or module(s), and/or may be implemented by one or more block(s) or module(s) not specifically illustrated in the example of FIG. 1. Generally, conventional functionality that may be useful to the system 100 of FIG. 1 may be included as well even though such conventional elements are not illustrated explicitly, for the sake of clarity and convenience.

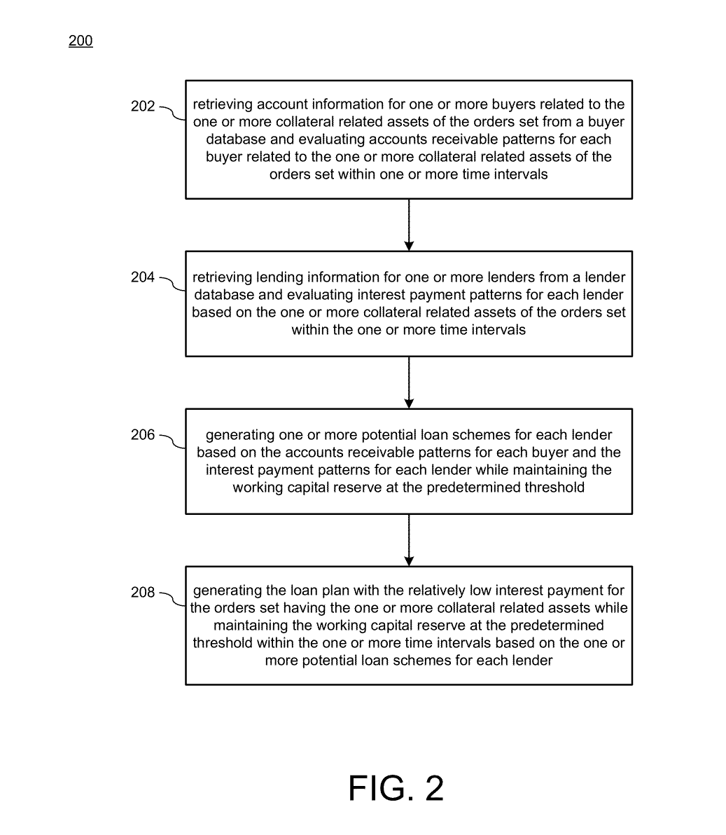

FIG. 2 is a process flow illustrating an example method 200 for supply chain finance (SCF) planning by implementing a genetic algorithm for loan planning, in accordance with aspects of the disclosure.

In the example of FIG. 2, operations 202-208 are illustrated as discrete operations occurring in sequential order. However, it should be appreciated that, in other implementations, two or more of the operations 202-208 may occur in a partially or completely overlapping or parallel manner, or in a nested or looped manner, or may occur in a different order than that shown. Further, one or more additional operations, that may not be specifically illustrated in the example of FIG. 2, may also be included in some implementations, while, in other implementations, one or more of the operations 202-208 may be omitted, without departing from the scope of the disclosure.

In the example of FIG. 2, the method 200 may include a process flow for a computer-implemented method for supply chain finance planning in the supply chain finance management system 100 of FIG. 1. Further, as described herein, the operations 202-208 provide an operational process flow that may be enacted by the computer system 104 to provide features and functionalities as described in reference to FIG. 1.

In an aspect of the disclosure, the method 200 is provided for generating one or more loan plans with a relatively low interest payment for an orders set having one or more collateral related assets while maintaining a working capital reserve (e.g., a cash reserve) at a predetermined threshold. In an implementation, the one or more collateral related assets of the orders set may include one or more of invoices, shipping certificates, acceptance certificates, and/or purchase orders as collateral related assets associated with one or more of the buyers.

In the example of FIG. 2, at 202, the method 200 may include retrieving account information for one or more buyers related to the one or more collateral related assets of the orders set from a buyer database (e.g., buyers database 140) and evaluating accounts receivable patterns for each buyer related to the one or more collateral related assets of the orders set within one or more time intervals.

At 204, the method 200 may include retrieving lending information for one or more lenders from a lender database (e.g., lenders database 142) and evaluating interest payment patterns for each lender based on the one or more collateral related assets of the orders set within the one or more time intervals.

At 206, the method 200 may include generating one or more potential loan schemes for each lender based on the accounts receivable patterns for each buyer and the interest payment patterns for each lender while maintaining the working capital reserve at the predetermined threshold. In an implementation, the method 200 may use a genetic algorithm for generating one or more potential loan schemes for each lender based on the accounts receivable patterns for each buyer and the interest payment patterns for each lender while maintaining the working capital reserve at the predetermined threshold.

In another implementation, the method 200 may use the genetic algorithm for generating the one or more potential loan schemes for each lender based on using the one or more collateral related assets of the orders set for a reduced interest rate for the relatively low interest payment while maintaining the working capital reserve at the predetermined threshold.

In another implementation, the method 200 may use the genetic algorithm for comparing a plurality of order-status chromosomes, wherein each order-status chromosome may include the one or more potential loan schemes for each lender within the one or more time intervals based on, for example, the accounts receivable patterns for each buyer and the interest payment patterns for each lender. The method 200 may use the genetic algorithm for comparing each of the plurality of order-status chromosomes relative to the predetermined threshold of the working capital reserve, to thereby output a selected subset of the plurality of order-status chromosomes. The method 200 may use the genetic algorithm for combining order-status chromosomes of the selected subset of the plurality of order-status chromosomes to obtain a next generation of order-status chromosomes for output to the chromosome comparator and for subsequent comparison therewith of the next generation of order-status chromosomes with respect to the predetermined threshold of the working capital reserve, as part of an evolutionary loop of the plurality of order-status chromosomes. In this instance, the method 200 may further include monitoring the evolutionary loop and selecting a selected order-status chromosome therefrom for implementation of the loan plan based thereon.

In another implementation, the method 200 may use the genetic algorithm for combining the order-status chromosomes including selecting pairs of order-status chromosomes and crossing over portions of each pair of order-status chromosomes to obtain a child chromosome of the next generation.

In another implementation, the method 200 may use the genetic algorithm for executing at least a portion of the evolutionary loop using parallel processes in which each generation of order-status chromosomes is divided into sub-groups for parallel processing thereof. In this instance, the method 200 may further include selecting the selected order-status chromosome after a predetermined number of generations of the evolutionary loop, or after determining that the selected order-status chromosome satisfies the predetermined threshold of the working capital reserve.

In the example of FIG. 2, at 208, the method 200 may include generating the loan plan with the relatively low interest payment for the orders set having the one or more collateral related assets while maintaining the working capital reserve at the predetermined threshold within the one or more time intervals based on the one or more potential loan schemes for each lender. In an implementation, maintaining the working capital reserve at the predetermined threshold may include maintaining a profit return rate at a predetermined threshold. In another implementation, maintaining the working capital reserve at the predetermined threshold may include maintaining an asset-liability ratio at a predetermined threshold.

In an implementation, the method 200 may further include evaluating the accounts receivable patterns for each buyer by receiving one or more purchase orders from each buyer related to the orders set, sending an invoice to each buyer after delivery of the one or more purchase orders, and receiving payment from each buyer or the rejected purchase order from each buyer after confirming whether the buyer accepted or rejected the delivery.

In an implementation, the method 200 may further include evaluating the accounts receivable patterns for each buyer based on purchase orders received from the one or more buyers and/or evaluating interest payment patterns for each lender based on the purchase orders received from the one or more buyers within the one or more time intervals.

In an implementation, the method 200 may further include evaluating the accounts receivable patterns for each buyer based on invoices sent to the one or more buyers after delivery of one or more purchase orders to the one or more buyers and/or evaluating interest payment patterns for each lender based on the invoices sent to the one or more buyers within the one or more time intervals.

In an implementation, the method 200 may further include evaluating the accounts receivable patterns for each buyer based on receipts paid by the one or more buyers for delivery of one or more purchase orders to the one or more buyers and/or evaluating interest payment patterns for each lender based on the receipts paid by the one or more buyers within the one or more time intervals.

In an implementation, the method 200 may further include evaluating each generated potential loan scheme for each lender and selecting a best potential loan scheme by considering a lowest interest rate for the relatively low interest payment from each lender while maintaining the working capital reserve at the predetermined threshold.

In the example of FIG. 2, the method 200 may be configured for supply chain finance planning by recommending one or more loan plans that meet cash reserve requirements. Further, the cash reserve requirements may be defined with hard or soft conditions, and a scoring function may be defined by users to weight importance of each cash reserve requirement.

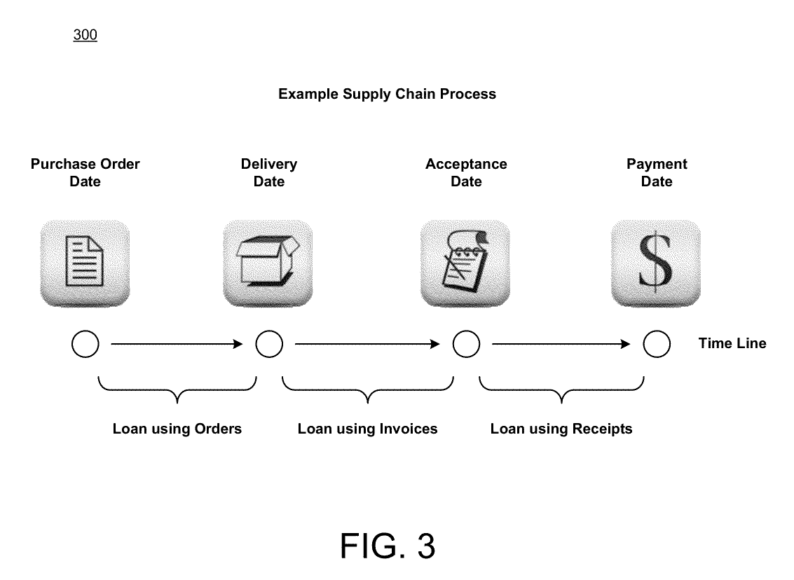

FIG. 3 is a schematic diagram illustrating an example supply chain process 300, in accordance with aspects of the disclosure.

In various implementations, supply chain finance (SCF) provides a means for addressing a supplier's cash flow and financing cost concerns. For instance, SCF may include a platform having one or more players including suppliers, buyers, and/or third-party funders (e.g., a financing institution, such as a bank). The suppliers may include a seller making and/or selling goods to the buyers, or the suppliers may include a supplier selling parts to the buyer for making products.

In reference to the example of FIG. 3, interaction between the supplier and the buyer during transactions may include one or more phases. For instance, a purchase order (PO) may be sent by the buyer and received by the supplier, which may refer to a purchase order date. In another instance, the purchase order may be delivered to the buyer, which may refer to a delivery date. The delivery may be defined as goods shipped and/or goods delivered to the buyer. After the goods are sent, the supplier may send out an invoice to the buyer. In another instance, after the goods are received by the buyer, the buyer may accept the goods, which may refer to an acceptance date, or return the goods if defeats are found in the goods. In another instance, upon confirmation of receiving goods in good order, the buyer may then pay the supplier at the payment due date or before the payment due date.

In an example, SCF may refer to a tripartite value proposition for lenders (banks), buyers, and suppliers. In some instances, the suppliers may be subject to high financing costs for short term loans to buy material or parts to fabricate final products for buyers, for example, when there may be a large order. With SCF, the suppliers may ask for a loan from third-party lenders or funders using collateral related assets, such as, for example, purchase orders, invoices, receipts, shipping certificates, acceptance certificates, as collateral along a time line. Referring to different mortgage types, third-party lenders may earn a fair rate of return while the supplier achieves flexible working capital similar to a line of credit to accept large orders without massive capital investment up front, which may contribute to uncertainty of the supplier whether large purchase orders should be accepted or not. At the same time, the suppliers may optimize working capital reserves without hurting the buyers by passing the financial cost to the buyers. Thus, in some examples, SCF may be a win-win-win situation for all three parties.

As such, for the supplier, loan decisions may be considered important and may also be considered complex, wherein wise loan decisions may keep reduce funding problems. Further, loan timing may also be considered important. As shown in FIG. 3, the supplier may request a loan from a lender using different certificates, such as purchase orders, invoices, and/or receipts, which may incur different costs. The selective loan decision and/or timing may assist the supplier with saving costs and securing cash flow. When introducing parameters and/or variables (e.g., cash flow balance, return rate, maximum asset-liability ratio, etc) in a loan selection process, decision-making and calculation for addressing capacity expansion plans may not be feasible by a manual process or even by a computerized systematic search given the size of search space. As such, aspects of the disclosure describe a supply chain finance (SCF) planning solution to calculate an acceptable loan plan from the perspective of the supplier, which may reduce costs without impacting profit margins and while considering multiple objectives set by the supplier, in a manner as provided herein.

In an implementation, an input to SCF related loan planning may include a given orders set, cash flow target, and/or maximum asset-liability ratio. As such, aspects of the disclosure may be configured to generate one or more loan plans for a given orders set, a given cash flow target, a given return rate, and/or a given maximum asset-liability ratio. With a given return rate and maximum asset-liability ratio, implementations of algorithms of the disclosure may be configured to return an optimal loan plan with less cost for suppliers while providing consistent cash flow.

In some examples, various lenders may be asked for particular loans by suppliers, and each lender may have different lending schemes. Selection of different lenders may influence decisions, such as a maximum available loan percentage in each order status, which may incur different loan costs. Such facts may result in a large search space and more complexity for a solution. Aspects of the disclosure, as provided herein, describe technical approaches, algorithms, and implementation details including solutions for parallelizing searching tasks with pseudo code, and experimental results show that the proposed solution may work for other approaches including, for example, maintaining a cash reserve at or above a desirable threshold level, minimizing interest payments, and maintaining sufficient cash in reserve to accept more orders and larger orders.

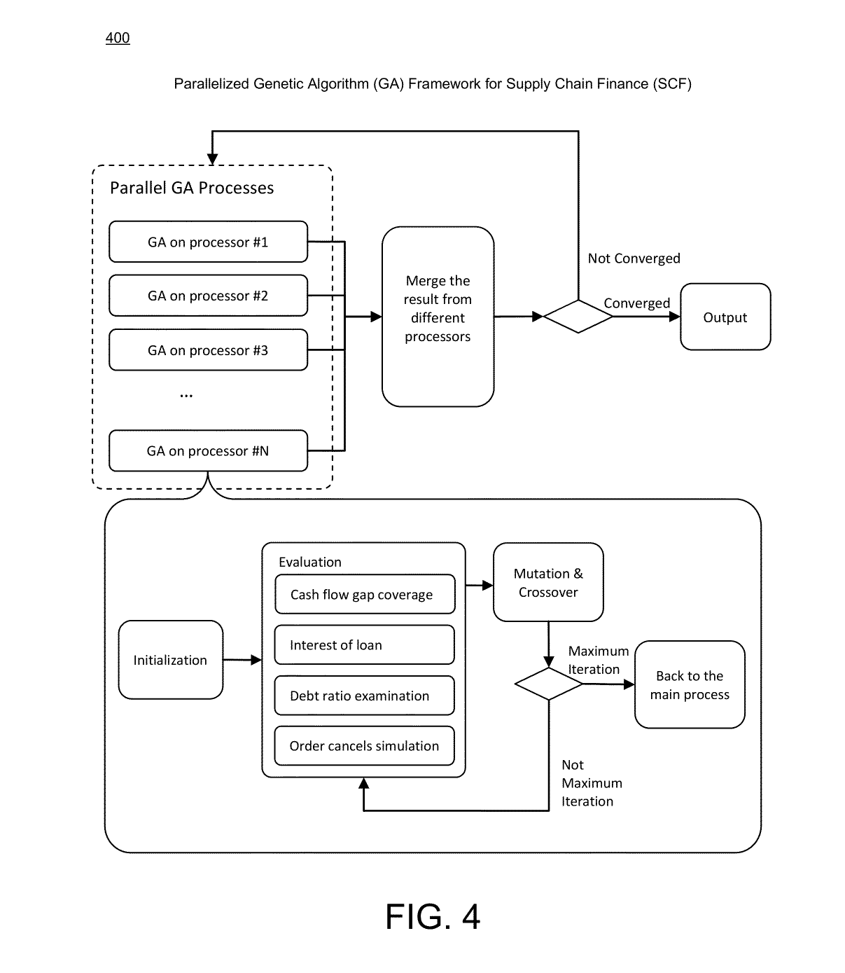

FIG. 4 is a schematic diagram illustrating an example parallelized genetic algorithm (GA) framework 400 for supply chain finance (SCF), in accordance with aspects of the disclosure.

In the example of FIG. 4, parallelized genetic algorithm (GA) processes may be configured to solve supply chain finance planning. The framework may include a series of genetic algorithm (GA) processes executing in parallel, wherein each of GA algorithm may evolve independently of each other GA algorithm. After a certain number of iterations, a merge process may be invoked. If a best result converges when compares to a last iteration, the system and/or methods may output the best result. Otherwise, the system and/or methods may initiate another batch of parallelized GA processes using current intermediate results as initial populations. These and various other related aspects are described in greater detail herein.

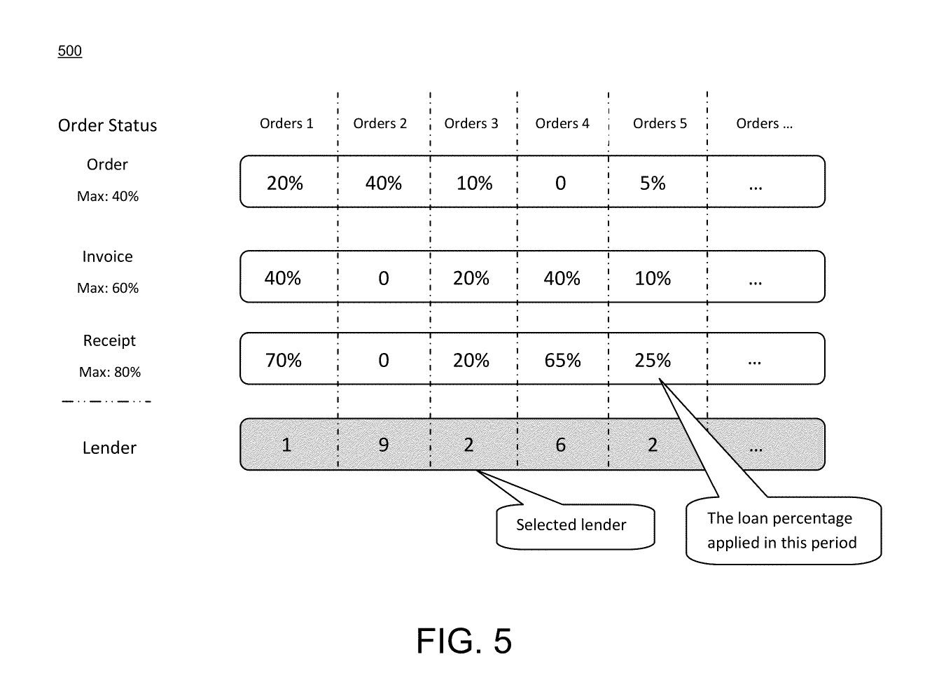

FIG. 5 is a schematic diagram illustrating an example chromosome representation 500, in accordance with aspects of the disclosure.

In the example of FIG. 5, a two dimensional table may be configured to represent a generated loan plan in a chromosome. For instance, a number of rows in the table may be considered equal to a number of purchase orders that may be used as collateral assets for a loan or mortgage, and a number of columns in the table may be considered equal to a number of statuses for each corresponding purchase order. In an example, each cell of the table may store a selected loan for a specific purchase order in a specific state. For instance, a value in a cell of 80% may refer to using that order to loan up to 80% of its possible worth in that state. Since short-term repaying may not be considered, a chromosome generating function may consider that a percentage increases monotonously though the entire process for a single order, and the chromosome may be generated to provide a loan value that does not exceed a maximum amount allowed.

% Chromosome structure
% numOfStatus: the number of status
% numOfOrders: the number of orders
Structure Chromosome
{
int LoanPlan[numOfStatus+1][ numOfOrders];
}

In an implementation, input to the supply chain finance manager 120 of FIG. 1 may include a predicted or given cash flow statement within a period of time (i.e., time interval) for future cash flow, a set of orders needed to process, and/or a set of loan parameters provided by the lenders. The proposed supply chain finance manager 120 may be configured to generate an optimal loan plan to fulfill gaps in cash flow with a lowest cost. Since the search space of a solution may be rather large, the search process may be performed using a genetic algorithm (GA) based approach.

% Parallel Genetic Algorithm
% M: the number of chromosomes each generation has
% N: the number of processes used
% Chromosomes: one generation, which is an array with M chromosomes
1. FUNCTION PARALLEL_GA
2. BEGIN
3. Generate M random valid Chromosomes
4. WHILE NOT CONVERGED
5. Allocate them to N processes equally
6. ON EACH Process: (Parallel)
7. CALL FUNCTION EVOLUTION;
8. IF converged, RETURN M/N intermediate result
9. Merge and get new generation Chromosomes[M]_{new}
10. FOR i := 0 to M−1 DO
11. CALL FUNCTION EVALUATE(Chromosomes[i])
12. END FOR
13. Sort(Chromosomes)
14. Select top 20%, and Re-generate M Child Chromosomes
15. % Next Generation
16. END WHILE
17.END
% Evolution
1. FUNCTION EVOLUTION
2. BEGIN
3. FOR EACH chromosome in current generation
4. CALL FUNCTION EVALUATE
5. Choose top 20%, crossover and mutate to generate next generation
6. END

In an implementation, factors that may be utilized in an evaluate function may consider a total interest need to pay plan and a cash flow status following a current loan plan. In an example, the following equation may be used to calculate total interest.

$$I = {\sum }_{i = 0}^{n} {r}_{i} {a}_{i}$$

where rᵢ denotes an interest rate of a loan, aᵢ denotes an amount of a loan, and i and n denote a total number of loans.

In an example, the interest rate may be found by looking up a loan interest table provided by each lender. The evaluation of cash flow may be somewhat complex, wherein the users may expect their cash flow to stay above a certain level, but keeping the cash flow at a meaningless high level may be considered unwise. As such, aspects of the disclosure may simultaneously consider everyday cash flow balance, risk introduced by the loan plan, and possible profits of a certain amount of redundant cash. For instance, gaps in the cash flow may be minimized, wherein a total amount of gaps may be represented using the following equation.

$$G = {\sum }_{i = 0}^{a} \text{?} ( {C}_{E} - {C}_{i} ) , a = \{ \begin{matrix}1 & {C}_{i} < {C}_{E} \\ 0 & {C}_{i} \geq {C}_{E}\end{matrix} \\ \text{?} \text{indicates text missing or illegible when filed}$$

where Cᵢ denotes a daily cash flow balance of day i, and C_{E} is an expected cash flow balance level specified by a user. In an example, if a business is at a high debt ratio and asking for more loans, a lender may consider debt paying ability of that particular business and may not lend money to them. As such, aspects of the disclosure may be configured to maintain a debt ratio of the business within or under a user specified level, wherein a ratio may be calculated daily using the following equation.

Debt Ratioₜ=Lₜ/Cₜ

In an example, aspects of the disclosure may be configured to consider the probability for customers or buyers to cancel purchase orders. In this situation, if a debt ratio of the business is at a high level, the business may need to repay a corresponding loan immediately. As such, aspects of the disclosure may be configured to evaluate a loan plan according to a user specified order cancellation probability.

In an implementation, the system and/or methods of the disclosure may be configured to utilize an evaluation function adapted to follow one or more rules including preferring to minimize a total cash flow gap G, preferring to minimize a total interest cost I of a loan plan, preferring to keep a daily debt ratio of a business staying below a certain level, and/or attempting to provide redundant cash flow amounts for possible order cancellation(s). In an example, since multiple objectives may be optimized, the system and/or methods of the disclosure may be configured to use a weighted sum approach to generate a general score for a loan plan, and a loan selection may be based on this score.

```
% Evaluate
1. FUNCTION EVALUATE(Chromosome chros)
2. BEGIN
3. score_total := 0;
4.
5. FOR i := 0 to numOfOrders DO
6. %Compute the interest to give for order i
7. interest_i = computeInterest(LoanPlan[ ][i]);
8. score_total += interest_i;
9. END FOR
10. Compute the cash flow, the overdue fine or discount, and get
    the score_CashFlow
11. Randomly simulate the order cancellation problem, if there is a
    gap, do punishment.
12. score_total += score_CashFlow;
13. Return score_total
14.END
```

In an implementation, a crossover process may be configured to occur between two chromosomes, wherein random segments may be chosen or selected from two parents to generate a new chromosome. The chromosome with a higher score may contribute more to the offspring. After a new chromosome is generated, a verification process may be invoked to validate a new generated plan.

```
    % Crossover
    % numOfStatus: the number of status
    % numOfOrders: the number of orders
    FUNCTION CROSSOVER (Chromosome Chr1, Chromosome Chr2)
    1. BEGIN
    2.  FOR i := 0 to numOfStatus DO
    3.  Randomly select R positions where the crossover will happen,
and denoted by pos[R]. (R< numOfOrders, and 0 ≦ pos[R] ≦
numOfOrders−1
    4.  Swap the value of Chr1[i][pos[R]] and Chr2[i][pos[R]]
    5.  END FOR
    6.
    7.  Return new Chr1 and Chr2
    8. END
```

In an implementation, a mutation process may be used to avoid a local optimal result, wherein random R positions may be chosen or selected in the loan plan, and the values in those cells may be changed. The chromosome with a higher score may slightly change when compared to other chromosomes.

```
    % Mutate
    % numOfStatus: the number of status
    % numOfOrders: the number of orders
    FUNCTION MUTATE (Chromosome Chr)
    1. BEGIN
    2.  FOR i := 0 to numOfStatus DO
    3.  Randomly select R positions where the mutate process will
happen, and denoted by pos[R]. (R< numOfOrders, and 0 ≦ pos[R] ≦
numOfOrders−1)
    4.  FOR j:= 0 to pos[R] DO
    5.  Randomly select a value from the possible value set to
replace the value at LoanPlan[i][j]
    6.  END FOR
    7.  END FOR
    8.  Return new Chr
    9. END
```

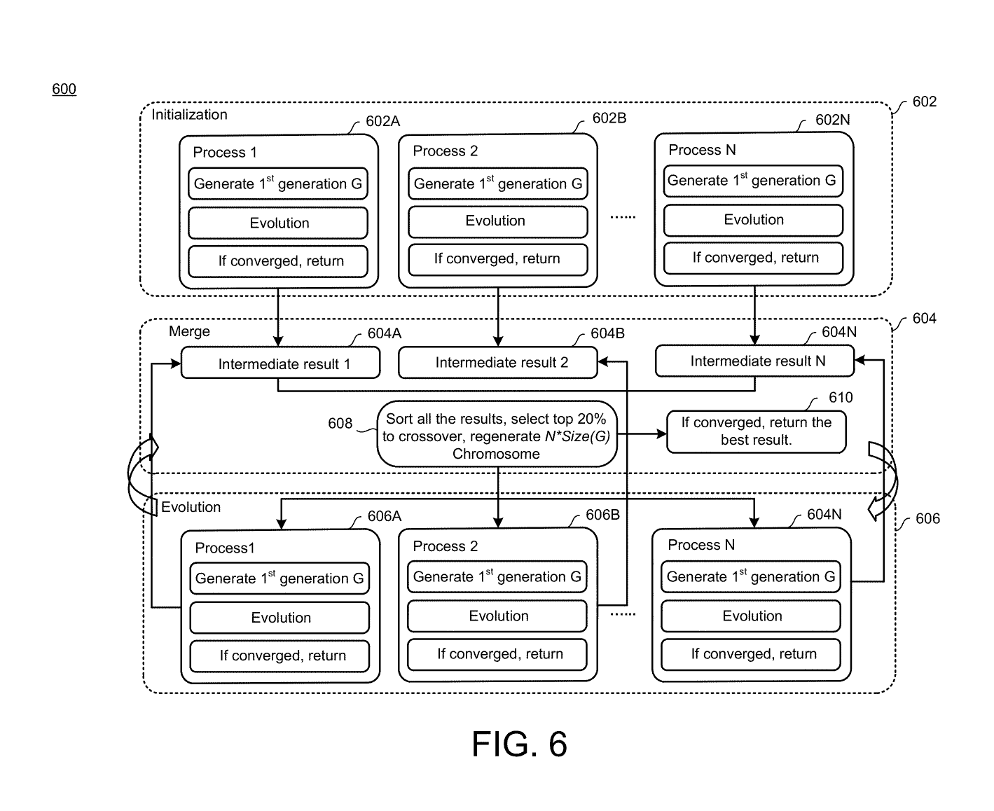

FIG. 6 is a block diagram illustrating an example framework 600 for supply chain finance (SCF) planning by implementing a genetic algorithm for loan planning in a manner consistent with methods provided herein. In an implementation, the framework 600 illustrates a parallel framework in which the various operations of the loan selection optimizer 126 and the genetic algorithm handler 130 may be parallelized to obtain faster, more efficient results.

In this regard, two, three, or more processors may be utilized to divide tasks of a larger computational task so as to obtain computational results in a faster, more efficient manner. Such parallelization may include division of subtasks to be executed in parallel among a specified number of processors, whereupon independent, parallel processing of the assigned subtasks may proceed, until such time as it may be necessary or desired to rejoin or otherwise combine results of the parallel threads of computation into a unified intermediate or final result for the computational task as a whole.

In this regard, it should be appreciated that such parallelization may be implemented using any multi-computing platform in which a plurality of processors, central processing units (CPUs), or other processing resources are available, including network/device clusters. For example, such parallel processing may utilize existing SMP/CMP (Symmetrical Multi-Processing/Chip-level Multi-Processing) servers. Thus, in the present description, it should be appreciated that the described processes may each be executed using such a corresponding unit(s) of processing power within any such environment in which multiple processing options are available. For example, it may be appreciated that the at least one processor 110 of FIG. 1 may be understood to represent any two or more of the above-referenced implementations for executing parallel processing, or other platforms for parallel processing, as would be apparent.

In the example of FIG. 6, an initialization stage 602 is illustrated in which “N” processes 602A, 602B, . . . 602N are illustrated. As illustrated, each process 602A-602N represents a separate instance of the above-described evolutionary loop of the genetic algorithm handler 130. Specifically, as shown in each of the processes 602A-602N, a generation “G” of chromosomes may be generated, whereupon evolution of subsequent generations of chromosomes may be conducted, until such time as if and when the loan selection optimizer 126 may identify a desired type and extent of convergence. As may be appreciated, the chromosome generations of the initial processes 602A-602N may be generated in random fashion. In other example implementations, the initial populations may be generated using one or more techniques designed to provide at least a high level of design which attempts to optimize associated schedules, or at least to eliminate inclusion of unworkable or otherwise undesirable potential schedules.

In a subsequent merge stage 604, intermediate results 604A, 604B . . . 604N may be combined, so that, in an operation 608, the combined results may be sorted, and the top 20% (or other designated portion) may be selected for use in creating a subsequent generation of chromosomes. Specifically, the selected portion of a current generation of chromosomes may be utilized to perform the types of crossovers described herein, or other known types of crossovers.

In the example of FIG. 6, individual pairs of chromosomes may be crossed over multiple times, for example, such that a subsequent generation of chromosomes includes N*size (G) chromosomes (i.e., includes a same number of chromosomes as a current generation). For instance, in the example of FIG. 6, since a top 20% of sorted chromosomes may be selected, each pair of chromosomes may be utilized to generate a plurality of new child chromosomes so as to maintain a same number of chromosomes in each generation.

If the overall operation is designated as having converged in conjunction with the operation 608, then the best result (i.e., the chromosome representing the best schedule according to the designated metric of profit maximum and/or utilization maximization) may be returned, as shown in operation 610. Otherwise, an evolution operation 606 may proceed with a re-parallelization of the new, child chromosome population generated in the operation 608.

Specifically, as shown, processes 606A, 606B . . . 606N may execute a new, current iteration of processing of the generated population chromosomes, in a manner that is substantially identical to the processes 602A, 602B . . . 602N with respect to the initialization operations 602. Subsequently, intermediate results 604A, 604B . . . 604N corresponding respectively to the processes 606A, 606B . . . 606N may be merged for subsequent sorting, crossover, and regeneration in the context of the operation 608. As may be appreciated, the operations 602, 604, 606 may proceed until convergence is reached at operation 610, and a best or best available result is obtained.

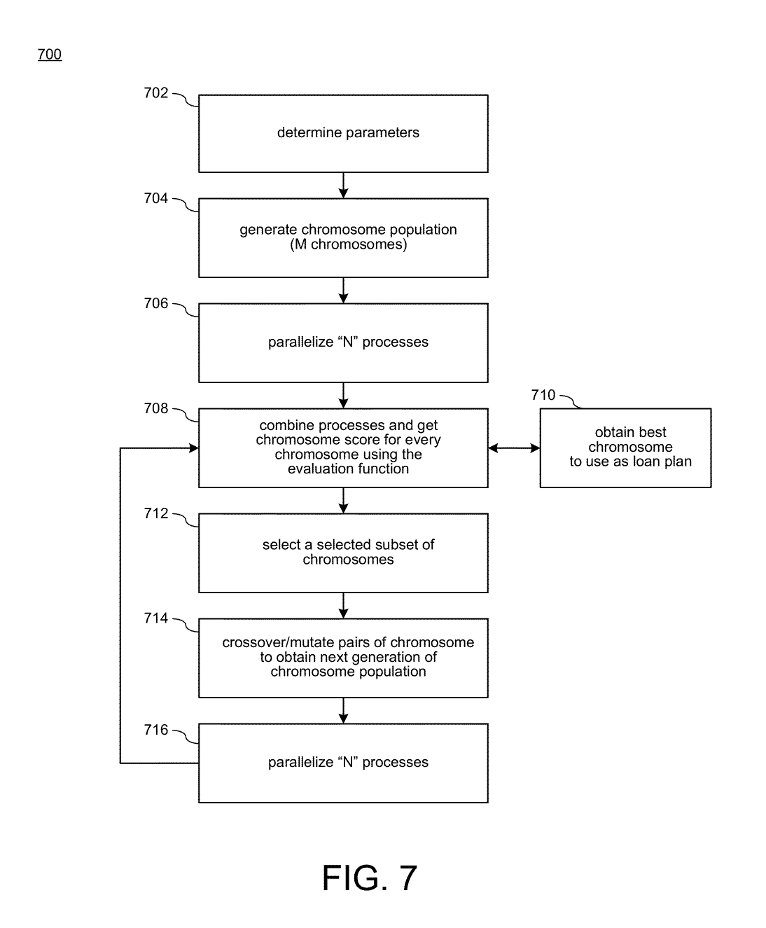

FIG. 7 is a process flow illustrating another example method 700 for supply chain finance (SCF) planning by implementing a genetic algorithm for loan planning in reference to the operations of the framework 600 of FIG. 6.

At 702, parameters may be determined. For example, parameters that characterize various portions of the chromosomes to be constructed and/or against which viability of the chromosomes may be judged, as well as a preferences received from a user for performing such judgments, (e.g., optimization of AP payment schedules for each lender within the one or more time intervals based on the determined confidence level (i.e., risk level) for each customer and one or more potential loan schemes for each lender while maintaining the predetermined threshold of the working capital reserve) may be determined. For example, as described, a user of the system 100 of FIG. 1 may utilize the GUI 152 to identify, designate, provide, or otherwise determine such information.

At 704, an initial chromosome population of “M” chromosomes may be generated. For example, the chromosome generator 128 may generate the first generation G of the processes 602A, 602B . . . 602N of FIG. 6.

At 706, “N” processes may be parallelized. For example, FIG. 6 illustrates an example of parallelization of “N” processes, e.g., in the initialization stage 602.

At 708, a chromosome score for every chromosome of the generation may be obtained by combining the various processes and using an appropriate evaluation function. For example, the chromosome comparator 134 may utilize such an evaluation function to associate a score with each chromosome of the generation. If convergence is reached according to one or more pre-determined criteria, then a best available order-status chromosome may be selected for use. For instance, if a chromosome receives a sufficiently high score, or if overall operations of the method 700 have provided a designated number of generations of chromosomes and/or have taken a designated total amount of time, then convergence may be understood to have occurred.

Otherwise, at 712, a selected subset of chromosomes may be selected. For example, the chromosome comparator 134 may select a top 20% of chromosomes as scored by the evaluation function.

At 714, pairs of the selected chromosomes may be subjected to crossovers and/or mutation to obtain a subsequent generation of chromosomes. For example, the chromosome combiner 136 may implement a type of crossover or combination in a manner as described herein.

At 716, parallelization of a subsequent “N” processes may proceed. For example, the chromosome comparator 134 may parallelize the end processes 606A, 606B . . . 606N as part of the evolution operation 606. In this way, a number of generations of chromosomes may be provided, until a suitable chromosome is obtained at 710. In an implementation, at 710, obtaining a suitable chromosome may include obtaining a best chromosome to use as a best loan plan (e.g., a most optimal loan plan).

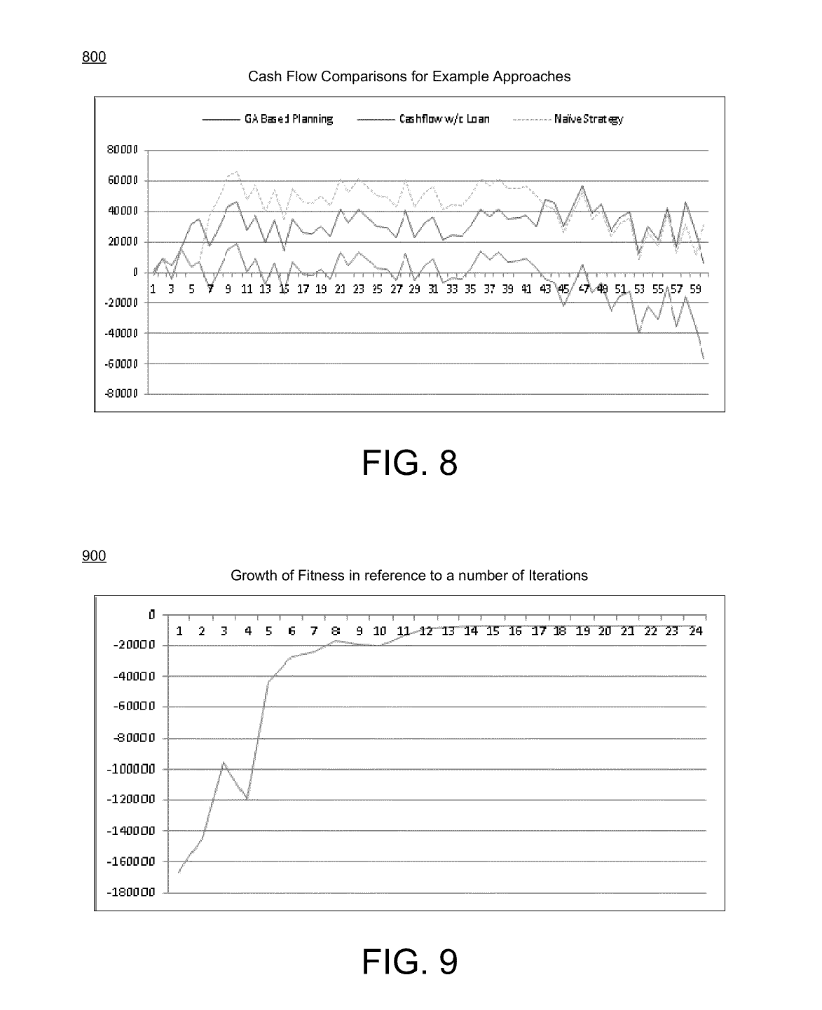

FIGS. 8-9 show various graphical illustrative examples of implementing the system and methods of FIGS. 1-7, in accordance with aspects of the disclosure. In particular, FIG. 8 is a graphical diagram illustrating example cash flow comparisons for some example approaches, and FIG. 9 is a graphical diagram illustrating example growth of fitness in reference to a number of iterations.

In the example of FIG. 8, a small data set may be used to examine or analyze a plurality of supply chain finance (SCF) planning solutions as compared with a naive strategy. For instance, the naive strategy refers to whether there is a cash gap, and a set of orders may be used for a loan to fill that gap. In an example, this method may be considered for only local optimization and may not be considered as a GA based method for global optimization.

In an implementation, referring to the following table, both of the two methods may be used to cover all gaps in an original cash flow, but a simple strategy may include keeping a cash flow balance at a useless high level than a GA base method. This technique may produce more interest, and the interest of this result may be 1119.5, while the simple strategy may need 2640.

TABLE
Test Specifications

Test Input
Cash flow balance forecast of next 60 days
Records of 30 orders in the next 60 days
Financial statement
Possibility of order cancellation is set to 5%
Debt/equity ratio threshold is set to 0.5
GA Settings
100 chromosomes per generation
Max iteration is set to 200
Probability of mutation is set to 0.2

In an implementation, referring to the example of FIG. 9, a fitness function may be configured to grow, and for a test data set, the system and/or methods provided herein may need about 15 generations to achieve a stable result. In another example, for to a larger data set, when referring to more purchase orders, the search process may need more iterations to be stable.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, may be written in any form of programming language, including compiled or interpreted languages, and may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for user interaction, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other types of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of networks, such as communication networks, may include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer system including instructions recorded on a computer-readable medium and executable by at least one processor, the system comprising:
a supply chain finance manager configured to cause the at least one processor to generate a loan plan with a relatively low interest payment for an orders set having one or more collateral related assets while maintaining a working capital reserve at a predetermined threshold, wherein the supply chain finance manager includes:
a buyer handler configured to retrieve account information for one or more buyers related to the one or more collateral related assets of the orders set from a buyer database and evaluate accounts receivable patterns for each buyer related to the one or more collateral related assets of the orders set within one or more time intervals;
a lender handler configured to retrieve lending information for one or more lenders from a lender database and evaluate interest payment patterns for each lender based on the one or more collateral related assets of the orders set within the one or more time intervals;
a genetic algorithm handler configured to generate one or more potential loan schemes for each lender based on the accounts receivable patterns for each buyer and the interest payment patterns for each lender while maintaining the working capital reserve at the predetermined threshold; and
a loan selection optimizer configured to generate the loan plan with the relatively low interest payment for the orders set having the one or more collateral related assets while maintaining the working capital reserve at the predetermined threshold within the one or more time intervals based on the one or more potential loan schemes for each lender.

2. The system of claim 1, wherein the one or more collateral related assets of the orders set include one or more of invoices, shipping certificates, acceptance certificates, and purchase orders as collateral related assets associated with one or more of the buyers.

3. The system of claim 1, wherein the maintaining the working capital reserve at the predetermined threshold includes maintaining a profit return rate at a predetermined threshold.

4. The system of claim 1, wherein the maintaining the working capital reserve at the predetermined threshold includes maintaining an asset-liability ratio at a predetermined threshold.

5. The system of claim 1, wherein the buyer handler is further configured to evaluate the accounts receivable patterns for each buyer by:
receiving one or more purchase orders from each buyer related to the orders set;
sending an invoice to each buyer after delivery of the one or more purchase orders; and
receiving payment from each buyer or the rejected purchase order from each buyer after confirming whether the buyer accepted or rejected the delivery.

6. The system of claim 1, wherein the buyer handler is further configured to evaluate the accounts receivable patterns for each buyer based on purchase orders received from the one or more buyers, and wherein the lender handler is further configured to evaluate interest payment patterns for each lender based on the purchase orders received from the one or more buyers within the one or more time intervals.

7. The system of claim 1, wherein the buyer handler is further configured to evaluate the accounts receivable patterns for each buyer based on invoices sent to the one or more buyers after delivery of one or more purchase orders to the one or more buyers, and wherein the lender handler is further configured to evaluate interest payment patterns for each lender based on the invoices sent to the one or more buyers within the one or more time intervals.

8. The system of claim 1, wherein the buyer handler is further configured to evaluate the accounts receivable patterns for each buyer based on receipts paid by the one or more buyers for delivery of one or more purchase orders to the one or more buyers, and wherein the lender handler is further configured to evaluate interest payment patterns for each lender based on the receipts paid by the one or more buyers within the one or more time intervals.

9. The system of claim 1, wherein genetic algorithm handler is further configured to:
generate the one or more potential loan schemes for each lender based on using one or more collateral related assets of the orders set for a reduced interest rate for the relatively low interest payment while maintaining the working capital reserve at the predetermined threshold.

10. The system of claim 1, wherein the loan selection optimizer is configured to:
evaluate each generated potential loan scheme for each lender; and
select a best potential loan scheme by considering a lowest interest rate for the relatively low interest payment from each lender while maintaining the working capital reserve at the predetermined threshold.

11. The system of claim 1, wherein the genetic algorithm handler comprises:
a chromosome comparator configured to compare a plurality of order-status chromosomes, each order-status chromosome including the one or more potential loan schemes for each lender within the one or more time intervals based on the accounts receivable patterns for each buyer and the interest payment patterns for each lender, and configured to compare each of the plurality of order-status chromosomes relative to the predetermined threshold of the working capital reserve, to thereby output a selected subset of the plurality of order-status chromosomes; and
a chromosome combiner configured to combine order-status chromosomes of the selected subset of the plurality of order-status chromosomes to obtain a next generation of order-status chromosomes for output to the chromosome comparator and for subsequent comparison therewith of the next generation of order-status chromosomes with respect to the predetermined threshold of the working capital reserve, as part of an evolutionary loop of the plurality of order-status chromosomes between the chromosome comparator and the chromosome combiner,
wherein the loan selection optimizer is further configured to monitor the evolutionary loop and select a selected order-status chromosome therefrom for implementation of the loan plan based thereon.

12. The system of claim 11, wherein the chromosome combiner is further configured to combine the order-status chromosomes including selecting pairs of order-status chromosomes and crossing over portions of each pair of order-status chromosomes to obtain a child chromosome of the next generation.

13. The system of claim 11, wherein at least a portion of the evolutionary loop is executed using parallel processes in which each generation of order-status chromosomes is divided into sub-groups for parallel processing thereof.

14. The system of claim 11, wherein the loan selection optimizer is further configured to select the selected order-status chromosome after a predetermined number of generations of the evolutionary loop, or after determining that the selected order-status chromosome satisfies the predetermined threshold of the working capital reserve.

15. A computer-implemented method, comprising:
generating a loan plan with a relatively low interest payment for an orders set having one or more collateral related assets while maintaining a working capital reserve at a predetermined threshold by:
retrieving account information for one or more buyers related to the one or more collateral related assets of the orders set from a buyer database and evaluating accounts receivable patterns for each buyer related to the one or more collateral related assets of the orders set within one or more time intervals;
retrieving lending information for one or more lenders from a lender database and evaluating interest payment patterns for each lender based on the one or more collateral related assets of the orders set within the one or more time intervals;
generating one or more potential loan schemes for each lender based on the accounts receivable patterns for each buyer and the interest payment patterns for each lender while maintaining the working capital reserve at the predetermined threshold; and
generating the loan plan with the relatively low interest payment for the orders set having the one or more collateral related assets while maintaining the working capital reserve at the predetermined threshold within the one or more time intervals based on the one or more potential loan schemes for each lender.

16. The method of claim 15, further comprising:
comparing a plurality of order-status chromosomes, each order-status chromosome including the one or more potential loan schemes for each lender within the one or more time intervals based on the accounts receivable patterns for each buyer and the interest payment patterns for each lender;
comparing each of the plurality of order-status chromosomes relative to the predetermined threshold of the working capital reserve, to thereby output a selected subset of the plurality of order-status chromosomes;
combining order-status chromosomes of the selected subset of the plurality of order-status chromosomes to obtain a next generation of order-status chromosomes for output to the chromosome comparator and for subsequent comparison therewith of the next generation of order-status chromosomes with respect to the predetermined threshold of the working capital reserve, as part of an evolutionary loop of the plurality of order-status chromosomes between the chromosome comparator and the chromosome combiner; and
monitoring the evolutionary loop and select a selected order-status chromosome therefrom for implementation of the loan plan based thereon.

17. The method of claim 16, further comprising:
combining the order-status chromosomes including selecting pairs of order-status chromosomes and crossing over portions of each pair of order-status chromosomes to obtain a child chromosome of the next generation;
executing at least a portion of the evolutionary loop using parallel processes in which each generation of order-status chromosomes is divided into sub-groups for parallel processing thereof; and
selecting the selected order-status chromosome after a predetermined number of generations of the evolutionary loop, or after determining that the selected order-status chromosome satisfies the predetermined threshold of the working capital reserve.

18. A computer program product, the computer program product being tangibly embodied on a computer-readable storage medium and comprising instructions that, when executed by at least one processor, are configured to:
generate a loan plan with a relatively low interest payment for an orders set having one or more collateral related assets while maintaining a working capital reserve at a predetermined threshold, wherein the instructions, when executed by the at least one processor, are further configured to:
retrieve account information for one or more buyers related to the one or more collateral related assets of the orders set from a buyer database and evaluate accounts receivable patterns for each buyer related to the one or more collateral related assets of the orders set within one or more time intervals;
retrieve lending information for one or more lenders from a lender database and evaluate interest payment patterns for each lender based on the one or more collateral related assets of the orders set within the one or more time intervals;
generate one or more potential loan schemes for each lender based on the accounts receivable patterns for each buyer and the interest payment patterns for each lender while maintaining the working capital reserve at the predetermined threshold; and
generate the loan plan with the relatively low interest payment for the orders set having the one or more collateral related assets while maintaining the working capital reserve at the predetermined threshold within the one or more time intervals based on the one or more potential loan schemes for each lender.

19. The computer program product of claim 18, further comprising instructions that, when executed by the processor, are configured to:
compare a plurality of order-status chromosomes, each order-status chromosome including the one or more potential loan schemes for each lender within the one or more time intervals based on the accounts receivable patterns for each buyer and the interest payment patterns for each lender;
compare each of the plurality of order-status chromosomes relative to the predetermined threshold of the working capital reserve, to thereby output a selected subset of the plurality of order-status chromosomes;
combine order-status chromosomes of the selected subset of the plurality of order-status chromosomes to obtain a next generation of order-status chromosomes for output to the chromosome comparator and for subsequent comparison therewith of the next generation of order-status chromosomes with respect to the predetermined threshold of the working capital reserve, as part of an evolutionary loop of the plurality of order-status chromosomes between the chromosome comparator and the chromosome combiner; and
monitor the evolutionary loop and select a selected order-status chromosome therefrom for implementation of the loan plan based thereon.

20. The computer program product of claim 19, further comprising instructions that, when executed by the processor, are configured to:
combine the order-status chromosomes including selecting pairs of order-status chromosomes and crossing over portions of each pair of order-status chromosomes to obtain a child chromosome of the next generation;
execute at least a portion of the evolutionary loop using parallel processes in which each generation of order-status chromosomes is divided into sub-groups for parallel processing thereof; and
select the selected order-status chromosome after a predetermined number of generations of the evolutionary loop, or after determining that the selected order-status chromosome satisfies the predetermined threshold of the working capital reserve.
